(19) United States
(12) Patent Application Publication
(10) Pub. No.: US 2025/0267722 A1
(43) Pub. Date: Aug. 21, 2025

(54) RANDOM ACCESS METHOD AND APPARATUS, TERMINAL, NETWORK-SIDE DEVICE, AND MEDIUM

(71) Applicant: VIVO MOBILE COMMUNICATION CO., LTD., Dongguan (CN)

(72) Inventors: Kun YANG, Dongguan (CN); Pengfei WANG, Dongguan (CN); Dajie JIANG, Dongguan (CN); Xueming PAN, Dongguan (CN)

(21) Appl. No.: 19/202,298

(22) Filed: May 8, 2025

Related U.S. Application Data
(63) Continuation of application No. PCT/CN2023/128620, filed on Oct. 31, 2023.

(30) Foreign Application Priority Data
Nov. 10, 2022 (CN) 202211407155.8

(51) Int. Cl. H04W 74/0833

(52) U.S. Cl. CPC H04W 74/0833

(57) ABSTRACT

A random access method and apparatus, a terminal, and a network-side device are disclosed. The method includes: receiving, by a terminal, first information sent by a network-side device, the first information being used to indicate information about a plurality of synchronization signal groups, and each of the synchronization signal groups including at least one synchronization signal; determining, by the terminal, a plurality of target synchronization signals based on the information about the plurality of synchronization signal groups; and performing, by the terminal, random access by using the plurality of target synchronization signals.

### CROSS-REFERENCE TO RELATED APPLICATIONS

This application is a bypass continuation of International Patent Application No. PCT/CN2023/128620, filed on Oct. 31, 2023, which claims the benefit of and priority to Chinese Patent Application No. 202211407155.8, filed on Nov. 10, 2022, which is incorporated herein by reference in their entirety.

### TECHNICAL FIELD

This application pertains to the field of communication technologies, and specifically relates to a random access method and apparatus, a terminal, a network-side device, and a medium.

### BACKGROUND

Random access is a basic and important process in a communication system. A main objective of random access is to establish uplink synchronization and request a network to allocate an uplink resource to a terminal.

In a related technology, after completing downlink synchronization, the terminal detects signal quality of a synchronization signal block (Synchronization Signal and PBCH Block, SSB), and selects an appropriate SSB based on a threshold configured by the network. For example, if signal quality of one SSB is higher than the threshold, the terminal selects the

SSB meeting a condition. If a plurality of SSBs meet the condition, the terminal selects one of the SSBs (a selection scheme is determined by the terminal). If no SSB meets the condition, the terminal selects an SSB from an SSB full set (a selection scheme is determined by the terminal). After determining the SSB, the terminal performs random access that is based on the SSB.

In a scenario of distributed deployment of Transmission Reception Points (TRPs), or in a 6G cell free scenario, a synchronization signal is separately sent based on an Access Point (AP) node cluster to perform seamless coverage. If a synchronization signal is selected in the foregoing manner to perform random access, a probability of successful access is low.

### BRIEF SUMMARY

Embodiments of this application provide a random access method and apparatus, a terminal, a network-side device, and a medium, so as to resolve a problem of a low success rate of random access by a terminal.

According to a first aspect, a random access method is provided, where the method includes:
receiving, by a terminal, first information sent by a network-side device, where the first information is used to indicate information about a plurality of synchronization signal groups, and each of the synchronization signal groups includes at least one synchronization signal;
determining, by the terminal, a plurality of target synchronization signals based on the information about the plurality of synchronization signal groups; and
performing, by the terminal, random access by using the plurality of target synchronization signals.

According to a second aspect, a random access method is provided, where the method includes:
sending, by a network-side device, first information to a terminal, where the first information is used to indicate information about a plurality of synchronization signal groups, and each of the synchronization signal groups includes at least one synchronization signal.

According to a third aspect, a random access apparatus is provided, where the apparatus includes:
a receiving module, configured to receive first information sent by a network-side device, where the first information is used to indicate information about a plurality of synchronization signal groups, and each of the synchronization signal groups includes at least one synchronization signal;
a determining module, configured to determine a plurality of target synchronization signals based on the information about the plurality of synchronization signal groups; and
an access module, configured to perform random access by using the plurality of target synchronization signals.

According to a fourth aspect, a random access apparatus is provided, where the apparatus includes:
a sending module, configured to send first information to a terminal, where the first information is used to indicate information about a plurality of synchronization signal groups, and each of the synchronization signal groups includes at least one synchronization signal.

According to a fifth aspect, a terminal is provided, where the terminal includes a processor and a memory, the memory stores a program or instructions capable of running on the processor, and the program or the instructions are executed by the processor to implement the steps of the method according to the first aspect.

According to a sixth aspect, a terminal is provided, including a processor and a communication interface, where the communication interface is configured to receive first information sent by a network-side device, where the first information is used to indicate information about a plurality of synchronization signal groups, and each of the synchronization signal groups includes at least one synchronization signal; and the processor is configured to determine a plurality of target synchronization signals based on the information about the plurality of synchronization signal groups; and perform random access by using the plurality of target synchronization signals.

According to a seventh aspect, a network-side device is provided, where the network-side device includes a processor and a memory, the memory stores a program or instructions capable of running on the processor, and the program or the instructions are executed by the processor to implement the steps of the method according to the second aspect.

According to an eighth aspect, a network-side device is provided, including a processor and a communication interface, where the communication interface is configured to send first information to a terminal, where the first information is used to indicate information about a plurality of synchronization signal groups, and each of the synchronization signal groups includes at least one synchronization signal.

According to a ninth aspect, a communication system is provided, including a terminal and a network-side device, where the terminal may be configured to perform the steps of the method according to the first aspect, and the network-side device may be configured to perform the steps of the method according to the second aspect.

According to a tenth aspect, a readable storage medium is provided, where the readable storage medium stores a program or instructions, and the program or the instructions are executed by a processor to implement the steps of the method according to the first aspect, or to implement the steps of the method according to the second aspect.

According to an eleventh aspect, a chip is provided, where the chip includes a processor and a communication interface, the communication interface is coupled to the processor, and the processor is configured to run a program or instructions to implement the method according to the first aspect, or to implement the method according to the second aspect.

According to a twelfth aspect, a computer program/program product is provided, where the computer program/program product is stored on a storage medium, and the computer program/program product is executed by at least one processor to implement the steps of the method according to the first aspect, or to implement the steps of the method according to the second aspect.

In the embodiments of this application, after receiving the first information sent by the network-side device, the terminal may determine group information of a synchronization signal based on the information about the synchronization signal group in the first information, and select a plurality of target synchronization signals from the plurality of synchronization signal groups to perform a random access process. Even in a case that random access performed by using some target synchronization signals fails, the random access process can still be performed based on a remaining target synchronization signal, thereby effectively improving a success rate of random access and shortening an access delay.

### BRIEF DESCRIPTION OF DRAWINGS

FIG. 1 is a schematic diagram of a wireless communication system to which an embodiment of this application is applicable;

FIG. 2 is a first schematic flowchart of a random access method according to an embodiment of this application;

FIG. 3 is a first schematic diagram of determining a synchronization signal group according to an embodiment of this application;

FIG. 4 is a second schematic diagram of determining a synchronization signal group according to an embodiment of this application;

FIG. 5 is a third schematic diagram of determining a synchronization signal group according to an embodiment of this application;

FIG. 6 is a fourth schematic diagram of determining a synchronization signal group according to an embodiment of this application;

FIG. 7 is a schematic interaction flowchart of a random access method according to an embodiment of this application;

FIG. 8 is a second schematic flowchart of a random access method according to an embodiment of this application;

FIG. 9 is a first schematic diagram of a random access apparatus according to an embodiment of this application;

FIG. 10 is a second schematic diagram of a random access apparatus according to an embodiment of this application;

FIG. 11 is a schematic structural diagram of a communication device according to an embodiment of this application;

FIG. 12 is a schematic structural diagram of a terminal according to an embodiment of this application; and

FIG. 13 is a schematic structural diagram of a network-side device according to an embodiment of this application.

### DETAILED DESCRIPTION

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specified order or sequence. It should be understood that, terms used in this way may be interchangeable under appropriate circumstances, so that the embodiments of this application can be implemented in an order other than that illustrated or described herein. Moreover, the terms “first” and “second” typically distinguish between objects of one category rather than limiting a quantity of objects. For example, a first object may be one object or a plurality of objects. In addition, in the specification and claims, “and/or” represents at least one of connected objects, and the character “/” generally represents an “or” relationship between associated objects.

It should be noted that, a technology described in embodiments of this application is not limited to a Long Term Evolution (LTE)/LTE-advanced (LTE-A) system, and may be further applied to other wireless communication systems, such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-carrier Frequency Division Multiple Access (SC-FDMA) system, and another system. The terms “system” and “network” are often used interchangeably in the embodiments of this application. A technology described may be used for the systems and radio technologies described above, as well as other systems and radio technologies. The following describes a New Radio (NR) system for illustrative purposes, and NR terms are used in most of the following descriptions. However, these technologies are also applicable to communication systems such as a 6th Generation (6G) communication system other than NR system applications.

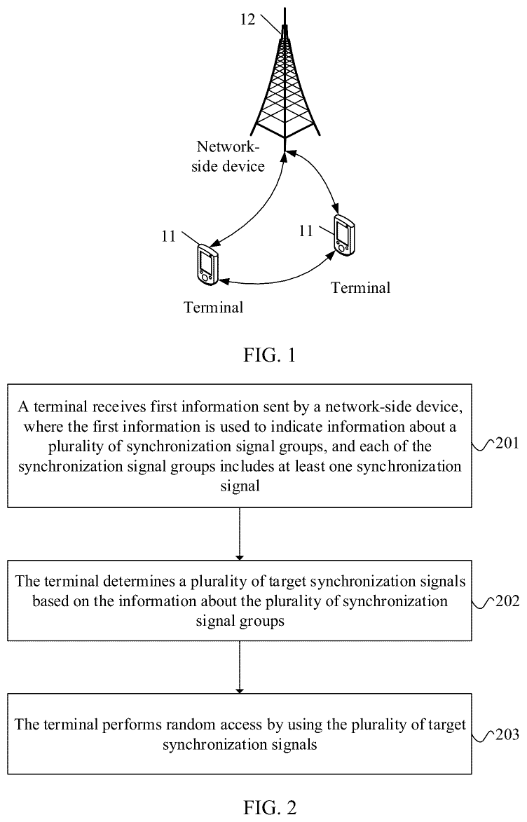

FIG. 1 is a schematic diagram of a wireless communication system to which an embodiment of this application is applicable. The wireless communication system shown in FIG. 1 includes a terminal 11 and a network-side device 12. The terminal 11 may be a mobile phone, a tablet personal computer, a laptop computer, also referred to as a notebook computer, a Personal Digital Assistant (PDA), a palmtop computer, a netbook, an Ultra-Mobile Personal Computer (UMPC), a Mobile Internet Device (MID), an Augmented Reality (AR)/a Virtual Reality (VR) device, a robot, a wearable device, Vehicle User Equipment (VUE), Pedestrian User Equipment (PUE), smart household (a household device having a wireless communication function, for example, a refrigerator, a television, a washing machine, or furniture), a game console, a Personal Computer (PC), or a terminal-side device such as an automated teller machine or a self-service machine. The wearable device includes a smart watch, a smart band, a smart headset, smart glasses, smart jewelry (a smart bracelet, a smart wrist chain, a smart ring, a smart necklace, a smart anklet, a smart ankle chain, and the like), a smart wrist strap, smart clothing, and the like. It should be noted that a specific type of the terminal 11 is not limited in this embodiment of this application.

The network-side device 12 may include an access network device or a core network device. The access network device may also be referred to as a radio access network device, a Radio Access Network (RAN), a radio access network function, or a radio access network unit. The access network device may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. The base station is not limited to a specific technical term provided that a same technical effect is achieved. It should be noted that in this embodiment of this application, only a base station in an NR system is used as an example for description, and a specific type of the base station is not limited.

To facilitate a clearer understanding of the technical solutions in the embodiments of this application, some technical content related to the embodiments of this application is first described.

A multi-TRP based beam management mechanism is introduced in Release (Rel) 17 of the Third Generation Partnership Project (3GPP) protocol. A Rel-17 terminal has X TRP modules, and Y TRP nodes are deployed on a base station. The base station configures M beams for the Rel-17 terminal, which are respectively from M TRP beam sets. M<=Y, and M<=X. The terminal measures a reference signal (an SSB or a Channel State Information-Reference Signal, CSI-RS) in the M beam sets, and reports N groups of measurement results. Each group of measurement results includes M measurement results, which respectively correspond to measurement results for one of the M beam sets. The Rel-17 terminal supports the use of X TRP modules to receive radio signals from M TRPs, respectively. According to the protocol, M=2, and N<=4.

The NR Rel-15 defines a 4-step random access procedure. After completing downlink synchronization, the terminal detects signal quality of an SSB, and selects an appropriate SSB based on a threshold (rsrp-ThresholdSSB) configured by the network. To be specific, if signal quality SS-RSRP of one SSB is higher than the threshold, the terminal selects the SSB meeting a condition. If a plurality of SSBs meet the condition, the terminal selects one of the SSBs (a selection scheme is determined by the terminal). If no SSB meets the condition, the terminal selects an SSB from an SSB full set (a selection scheme is determined by the terminal). After determining the SSB, the terminal determines, based on an association relationship between an SSB and a random access occasion (RACH occasion, RO), an RO resource set and a preamble resource set that are associated with the SSB. The terminal randomly selects one RO resource and one preamble resource from the resource set to send an MSG1.

Cell free large-scale multiple-input multiple-output (Multi Inputs Multi Out, MIMO) system: The cell free large-scale MIMO system may be considered as a deconstruction of a conventional large-scale MIMO system. In the conventional large-scale MIMO system, antennas are arranged at one station (base station) in a centralized manner, and terminals are distributed around the base station. In the large-scale MIMO system, a high array gain and spatial resolution are provided, but a signal to interference plus noise ratio of a terminal at a cell edge is reduced because coordinated transmission between adjacent base stations cannot be performed. In the cell free large-scale MIMO system, the concept of a cell is broken through, and a large quantity of antennas/TRP nodes/access points APs are deployed in a coverage area in a distributed manner. In theory, terminals in the coverage area may communicate with each TRP. By using a fronthaul network and a Central Processing Unit (CPU), a large quantity of geographically distributed TRPs may jointly serve a terminal, and the CPU performs joint detection by using channel statistics information. A cell free network is expected to be used in next-generation indoor and hotspot coverage scenarios, such as smart factories, railway stations, shopping centers, stadiums, subways, hospitals, community centers, or university campuses.

Currently, after completing downlink synchronization, the terminal detects signal quality of an SSB, and selects a unique SSB based on a threshold configured by the network to perform random access. In addition, in a scenario in which signal quality of a plurality of SSBs is similar, for example, in the cell free large-scale MIMO system, the terminal selects one SSB from a plurality of SSBs with similar signal quality. In this case, it is difficult to make a decision, implementation complexity of the terminal may be increased, and a probability of successful access is low.

For example, the network-side device may use a distributed multi-TRP deployment solution, in which each TRP sends one or more SSB signals to ensure that a nearby terminal accesses a cell. From a terminal perspective, the terminal selects only one SSB sent by one TRP to perform random access. However, in a case that the terminal has similar distances from a plurality of TRPs, signal quality of SSBs received by the terminal from the plurality of TRPs is similar. In this case, the terminal may not be able to accurately determine the optimal SSB.

To resolve the foregoing problem, in the embodiments of this application, a plurality of synchronization signals are selected for random access.

With reference to the accompanying drawings, a random access method and apparatus, a terminal, a network-side device, and a medium that are provided in the embodiments of this application are described below in detail by using some embodiments and application scenarios thereof.

FIG. 2 is a first schematic flowchart of a random access method according to an embodiment of this application. As shown in FIG. 2, the method includes the following steps.

Step 201: A terminal receives first information sent by a network-side device, where the first information is used to indicate information about a plurality of synchronization signal groups, and each of the synchronization signal groups includes at least one synchronization signal.

Specifically, the first information is used to indicate the information about the plurality of synchronization signal groups. Optionally, the information about the synchronization signal group includes information about a synchronization signal group to which a synchronization signal belongs, for example, information about a synchronization signal group to which each synchronization signal in a synchronization signal set belongs. The information may be specifically indicated in an explicit or implicit manner. Optionally, the information about the synchronization signal group may further include RO resource information associated with the synchronization signal, and the like. Each synchronization signal group includes at least one synchronization signal. Optionally, the first information is carried in a system message or higher layer signaling (for example, RRC signaling).

After receiving the first information sent by the network-side device, the terminal may determine group information of the synchronization signal based on the information about the synchronization signal group in the first information, for example, a specific quantity of synchronization signal groups, and specific synchronization signals included in each synchronization signal group.

Step 202: The terminal determines a plurality of target synchronization signals based on the information about the plurality of synchronization signal groups.

Specifically, after receiving the first information sent by the network-side device, the terminal may determine the group information of the synchronization signal based on the information about the synchronization signal group in the first information, and select a plurality of synchronization signals from the plurality of synchronization signal groups as the target synchronization signals, for example, may select a target synchronization signal based on signal quality. Optionally, one or more synchronization signals may be selected from one synchronization signal group as the target synchronization signals.

Specifically, the terminal determines M synchronization signal groups, and selects N synchronization signal groups for synchronization signal selection, where N<=M. One or A synchronization signals are selected from each of the N synchronization signal groups as the target synchronization signals, where A is predefined by a protocol or configured by a system message.

Step 203: The terminal performs random access by using the plurality of target synchronization signals.

Specifically, after the terminal determines the plurality of target synchronization signals based on the information about the plurality of synchronization signal groups, the terminal may perform a random access process by using the plurality of target synchronization signals in a random access phase based on RO resources corresponding to the plurality of target synchronization signals. Compared with a process in which the terminal performs random access based on a single synchronization signal, the terminal performs random access by using a plurality of target synchronization signals, which effectively improves a success rate of random access, shortens an access delay, and resolves a problem that an access success rate is low when the terminal selects only one SSB to perform random access.

For example, in a distributed multi-TRP deployment scenario, each TRP sends one or more SSB signals to ensure that a nearby terminal accesses a cell, and the terminal may simultaneously send PRACH signals to the plurality of TRPs, thereby increasing a success rate of random access by the terminal. Optionally, a Rel-17 terminal has a plurality of TRP modules, and supports simultaneous sending/receiving of a plurality of beams. The terminal may select a plurality of SSBs based on SSB monitoring results of a plurality of TRPs to perform random access in parallel, so as to improve a success rate of random access. Optionally, in a cell free network, the terminal may be simultaneously served by a plurality of TRPs in a form of a cooperative cluster, and the terminal may select a plurality of synchronization signals in the random access phase, thereby improving a success rate of random access and construction efficiency of the cooperative cluster.

In the method in the foregoing embodiment, after receiving the first information sent by the network-side device, the terminal may determine group information of a synchronization signal based on the information about the synchronization signal group in the first information, and select a plurality of target synchronization signals from the plurality of synchronization signal groups to perform a random access process. Even in a case that random access performed by using some target synchronization signals fails, the random access process can still be performed based on a remaining target synchronization signal, thereby effectively improving a success rate of random access and shortening an access delay.

In an embodiment, the first information includes at least one of the following:
first indication information, where the first indication information is used to indicate the information about the plurality of synchronization signal groups;
a quantity threshold of the synchronization signal groups to which the plurality of target synchronization signals belong;
an association relationship between a synchronization signal and an access occasion RO; and
a configuration parameter of an RO resource.

Specifically, the first information sent by the network-side device to the terminal may include the first indication information. The first indication information is used to indicate the information about the plurality of synchronization signal groups, so that the terminal can determine, based on the first indication information, information about a synchronization signal group to which each synchronization signal belongs and specific synchronization signals included in each synchronization signal group.

Optionally, the first information may alternatively include a quantity threshold of the synchronization signal groups to which the plurality of target synchronization signals belong, for example, a maximum quantity threshold, that is, a quantity of the target synchronization signals or a quantity of synchronization signal groups corresponding to the target synchronization signals does not exceed the maximum quantity threshold. Optionally, a quantity of synchronization signal groups to which the target synchronization signals belong is the same as a quantity of target synchronization signals finally selected by the terminal. In a case that the quantity threshold of the synchronization signal groups to which the target synchronization signals belong is greater, the quantity of the target synchronization signals is larger, and an access success rate is higher. If the quantity threshold is not explicitly configured, the terminal determines the quantity threshold based on a terminal capability, or determines the quantity threshold based on a predefinition in a protocol. The terminal capability is a maximum quantity of downlink signal beams simultaneously received by the terminal. It may be understood that a maximum quantity threshold of the target synchronization signal does not exceed a maximum quantity threshold configured by the network, and does not exceed a maximum quantity of received beams supported by the terminal capability.

Optionally, the first information may alternatively include an association relationship between a synchronization signal and an access occasion RO, so that after the terminal determines the plurality of target signals based on the first information sent by the network-side device, the terminal may determine, based on the association relationship between the synchronization signal and the access occasion RO in the first information, RO resources corresponding to the plurality of target synchronization signals, and perform random access.

Optionally, the first information may alternatively include a configuration parameter of an RO resource, so that the terminal can determine, based on the configuration parameter of the RO resource, the RO resource corresponding to the target synchronization signal, and perform random access. Optionally, the network-side device may configure only one RO resource set, that is, all SSBs are associated with one RO resource set. Alternatively, only one RO resource set is configured, and a plurality of synchronization signal groups are separately associated with the RO resource set. Alternatively, the network-side device configures a plurality of RO resource sets, which respectively correspond to the plurality of synchronization signal groups, and the synchronization signal groups are associated with respective RO resource sets. Further, optionally, if the plurality of synchronization signal groups are independently associated with the RO resource set, it is ensured that association periods of the synchronization signal groups are the same.

In an embodiment, the information about the plurality of synchronization signal groups includes at least one of the following:
information about a synchronization signal included in each of the synchronization signal groups;
information about a synchronization signal group to which each synchronization signal in a synchronization signal set belongs;
a quantity of synchronization signals in each of the synchronization signal groups;
a quantity of synchronization signal groups;
identifiers of a plurality of synchronization signals;
a first synchronization signal set, where the first synchronization signal set includes a synchronization signal identifier corresponding to a first synchronization signal in each synchronization signal group;
a second synchronization signal set, where the second synchronization signal set includes a synchronization signal identifier corresponding to a last synchronization signal in each synchronization signal group;
a synchronization signal bitmap, where target separation information in the synchronization signal bitmap is used to indicate a boundary for classifying a plurality of synchronization signals into a plurality of synchronization signal groups; and
location information of a Random Access Response (RAR) window corresponding to each RO.

Specifically, the first information sent by the network-side device to the terminal may include the first indication information. The first indication information is used to indicate the information about the plurality of synchronization signal groups, so that the terminal can determine, based on the information about the synchronization signal groups, information about a synchronization signal group to which each synchronization signal belongs and specific synchronization signals included in each synchronization signal group. Optionally, the network-side device may explicitly indicate the information about the synchronization signal groups to the terminal by using the first indication information, or may implicitly indicate the information about the synchronization signal groups, so that the terminal accurately determines the group information of the synchronization signal.

Optionally, the information about the synchronization signal groups may include information about a synchronization signal included in each synchronization signal group, that is, the first information sent by the network-side device explicitly indicates information about a synchronization signal included in each synchronization signal group. Therefore, the terminal can accurately know the group information of the synchronization signal.

Optionally, the information about the synchronization signal groups may alternatively include the information about the synchronization signal group to which each synchronization signal in the synchronization signal set belongs, that is, the first information sent by the network-side device explicitly indicates the information about the synchronization signal group to which each synchronization signal belongs. Therefore, the terminal can accurately know the group information of the synchronization signal.

Optionally, the information about the synchronization signal groups may alternatively include a quantity of synchronization signals in each synchronization signal group, so that the terminal can accurately determine the group information of the synchronization signal based on the quantity of synchronization signals in each synchronization signal group. Optionally, the terminal continuously arranges the synchronization signals based on the quantity of synchronization signals in each synchronization signal group, so as to determine synchronization signal information included in each synchronization signal group.

Optionally, the group information of the synchronization signal may be determined based on the quantity of synchronization signal groups. For example, the terminal determines, based on the quantity of synchronization signal groups and an implementation logic or a terminal capability of the terminal, the synchronization signal information included in each synchronization signal group. For example, it may be agreed in advance that quantities of synchronization signals in the synchronization signal groups are the same.

Optionally, the information about the synchronization signal groups may alternatively include an identifier of the synchronization signal, so that the terminal can accurately determine the group information of the synchronization signal based on the identifier of the synchronization signal. Optionally, the terminal performs mapping to a corresponding synchronization signal group based on the identifier of the synchronization signal and a modulus value of the quantity M of synchronization signal groups, to determine the group information of the synchronization signal. Optionally, the quantity of synchronization signal groups is 2 by default. The terminal may also determine the quantity of synchronization signal groups based on the terminal capability and an operating frequency band. For example, a quantity of synchronization signal groups corresponding to a frequency band of Frequency range 1 (FRI) is 2, and a quantity of synchronization signal groups corresponding to a frequency band of Frequency range 2 (FR2) is 4. The quantity of synchronization signal groups may alternatively be preconfigured by the network-side device.

Optionally, the information about the synchronization signal groups may alternatively include a first synchronization signal set and/or a second synchronization signal set. The first synchronization signal set includes a synchronization signal identifier corresponding to a first synchronization signal in each synchronization signal group, and the second synchronization signal set includes a synchronization signal identifier corresponding to a last synchronization signal in each synchronization signal group. Therefore, the terminal may determine, based on the first synchronization signal set and the second synchronization signal set, a synchronization signal identifier corresponding to a first synchronization signal in each synchronization signal group and a synchronization signal identifier corresponding to a last synchronization signal in each synchronization signal group. Further, the terminal may determine a range of synchronization signal identifiers separately included in each synchronization signal group, thereby accurately learning the group information of the synchronization signal. For example, the first synchronization signal set or the second synchronization signal set may alternatively be combined with the quantity of synchronization signal groups or the like to determine the group information of the synchronization signal. Alternatively, the group information of the synchronization signal may be determined based on the first synchronization signal set or the second synchronization signal set, and protocol agreement or preconfigured information.

Optionally, the information about the synchronization signal groups includes a synchronization signal bitmap. Target separation information in the synchronization signal bitmap is used to classify a plurality of synchronization signals into a plurality of synchronization signal groups, so that the terminal can determine the group information of the synchronization signal based on the target separation information in the synchronization signal bitmap. For example, in the synchronization signal bitmap, a group of synchronization signals is continuously arranged, synchronization signal groups are spaced by one or more empty synchronization signal resources, and synchronization signals between adjacent empty synchronization signal resources are synchronization signals of one synchronization signal group. The synchronization signal group may be implemented in time domain or in frequency domain.

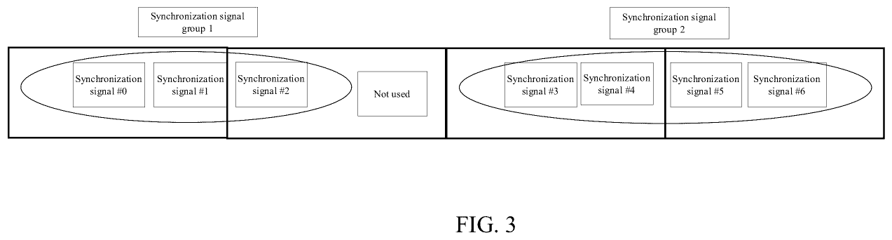

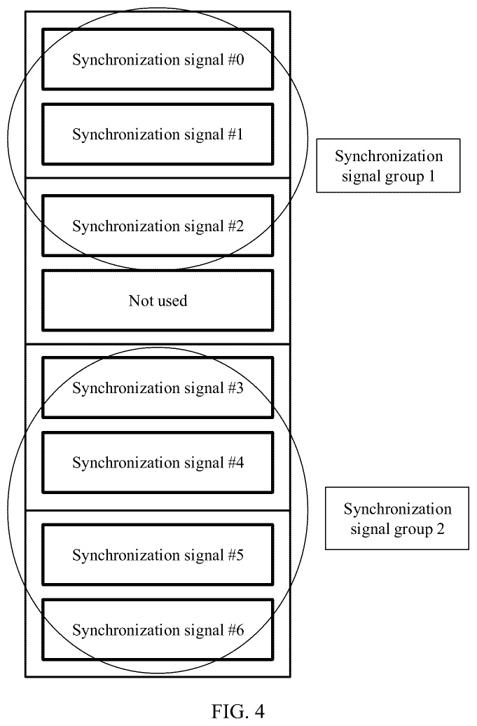

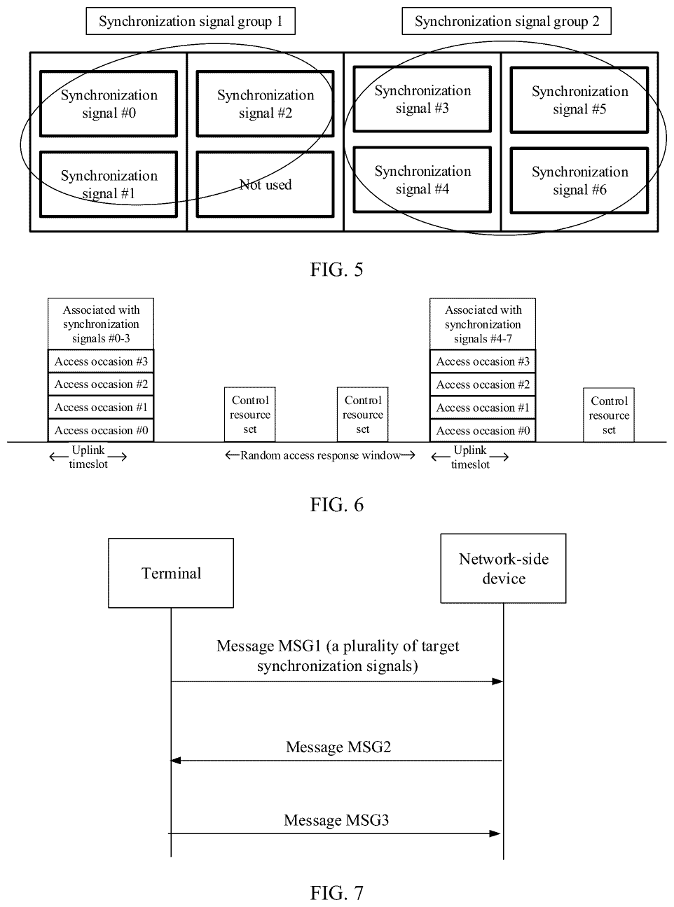

For example, as shown in FIG. 3, synchronization signal group 1 and synchronization signal group 2 are spaced in time domain by one synchronization signal resource, thereby implementing grouping of synchronization signals. As shown in FIG. 4, synchronization signal group 1 and synchronization signal group 2 are spaced in frequency domain by one synchronization signal resource, thereby implementing grouping of synchronization signals. As shown in FIG. 5, synchronization signal group 1 and synchronization signal group 2 are spaced in time domain and frequency domain by one synchronization signal resource, thereby implementing grouping of synchronization signals.

Optionally, the information about the synchronization signal groups may alternatively include location information of a random access response RAR window corresponding to each RO, so that the terminal can classify ROs having the same location information of the random access response RAR window into one group, and further determine, based on an association relationship between an RO and an SSB, an associated SSB group in the RO group, so as to determine a synchronization signal group. For example, as shown in FIG. 6, if RO#0, RO#1, RO#2, and RO#3 have the same random access response RAR window, RO#0, RO#1, RO#2, and RO#3 may be classified into one group. Further, it may be determined, based on the association relationship between an RO and an SSB, that SSB#0, SSB#1, SSB#2, and SSB#3 belong to the same synchronization signal group. Optionally, the association relationship between an SSB and an RO is mapped onto a corresponding RO resource based on each SSB group. Therefore, the terminal may determine an SSB group based on the SSB-RO association relationship. For example, FR2 is used as an example (it is assumed that each TRP supports single-beam sending/receiving). By default, it is considered that SSBs mapped onto RO resources in a same time period belong to different SSB groups, and sequentially correspond to different SSB groups based on an association sequence of SSBs in the same time period.

According to the method in the foregoing embodiment, the network-side device explicitly or implicitly indicates the group information of the synchronization signal by using the first information, so that after receiving the first information sent by the network-side device, the terminal can accurately determine the group information of the synchronization signal set based on the first information. Implementation complexity of the terminal is low, and there may be a plurality of indication manners, and flexibility is high.

In an embodiment, the determining, by the terminal, a plurality of target synchronization signals based on the information about the plurality of synchronization signal groups includes:
determining, by the terminal, at least one target synchronization signal group based on signal quality of a synchronization signal in the synchronization signal group; and
determining, by the terminal, the target synchronization signals based on each of the target synchronization signal group.

Specifically, the terminal determines the group information of the synchronization signal based on the information about the plurality of synchronization signal groups. To be specific, after determining the synchronization signal included in each synchronization signal group, the terminal may determine the at least one target synchronization signal group based on the signal quality of the synchronization signal in the synchronization signal group. In actual application, a basis for grouping synchronization signals is to distinguish synchronization signals corresponding to different TRPs or AP node clusters. Further, the terminal may alternatively determine, from the target synchronization signal group, a plurality of target synchronization signals to perform a random access process, thereby improving a success rate of random access.

In an embodiment, the determining, by the terminal, at least one target synchronization signal group based on signal quality of a synchronization signal in the synchronization signal group includes:
determining, by the terminal, signal quality of each synchronization signal group based on the signal quality of the synchronization signal in the synchronization signal group; and
selecting, by the terminal, at least one target synchronization signal group based on the signal quality of each synchronization signal group.

Specifically, the terminal may determine the signal quality of each synchronization signal group based on the signal quality of the synchronization signal in each synchronization signal group. For example, the terminal determines signal quality of M synchronization signal groups based on a weighted value or a maximum value or an average value of Reference Signal Receiving Power (RSRP) of the synchronization signals in the M synchronization signal groups, and further selects N target synchronization signal groups based on the signal quality of the M synchronization signal groups. Optionally, the terminal may select N synchronization signal groups with best signal quality, or select N synchronization signal groups that exceed a preset threshold as the target synchronization signal groups, or apply another rule for filtering a synchronization signal group, which is not limited herein. Optionally, N is less than or equal to M.

In an embodiment, the determining, by the terminal, the plurality of target synchronization signals based on each of the target synchronization signal group includes:
using, by the terminal, a synchronization signal with optimal signal quality in each target synchronization signal group as the plurality of target synchronization signals; and/or
using, by the terminal, a synchronization signal with signal quality greater than or equal to a first threshold in each target synchronization signal group as the plurality of target synchronization signals.

Specifically, after determining the plurality of target synchronization signal groups, the terminal may use a synchronization signal with optimal signal quality in each target synchronization signal group as the plurality of target synchronization signals; and/or use a synchronization signal with signal quality greater than or equal to a first threshold in each target synchronization signal group as the target synchronization signals.

For example, after the terminal determines the N target synchronization signal groups, the terminal may select one synchronization signal from each of the N synchronization signal groups as the target synchronization signals. Optionally, the terminal selects a synchronization signal with best RSRP from each target synchronization signal group as the target synchronization signal, or selects a synchronization signal with signal quality greater than or equal to a first threshold from each target synchronization signal group as the target synchronization signal. Optionally, if the signal quality of the synchronization signal group is lower than a predefined or preconfigured threshold, a synchronization signal may be randomly selected from the synchronization signal group as the target synchronization signal, or no target synchronization signal is selected from the synchronization signal group. Further, optionally, ROs associated with the target synchronization signals do not overlap in time domain.

Optionally, the terminal may alternatively select a plurality of target synchronization signals from one target synchronization signal group. This is not limited in this embodiment of this application. A quantity of the plurality of target synchronization signals in the target synchronization signal group is predefined by a protocol or configured by a system message.

In an embodiment, the quantity of a plurality of target synchronization signals is less than or equal to the quantity of antenna modules supported by the terminal, or the quantity of simultaneously received signal streams.

Specifically, the quantity N of the plurality of target synchronization signals selected by the terminal should be less than or equal to the quantity of antenna modules supported by the terminal or the quantity of simultaneously received signal streams, so that the terminal can effectively perform random access based on a plurality of target synchronization signals.

In an embodiment, the performing, by the terminal, random access by using the plurality of target synchronization signals includes:
performing, by the terminal, random access by using the plurality of target synchronization signals in at least one of the following cases:
the terminal receives second indication information sent by the network-side device, where the second indication information is used to indicate the terminal to perform random access that is based on a plurality of target synchronization signals;
a downlink path loss is less than or equal to a second threshold;
a quantity of failures of random access that is performed by the terminal based on a single synchronization signal is greater than or equal to a third threshold;
the terminal receives third indication information sent by the network-side device, where the third indication information is used to indicate that an area in which the terminal is located is a cell free area, and/or indicate that the terminal is served jointly by TRPs of a transmission reception point TRP cooperative cluster; and
a signal quality difference, obtained by the terminal through measurement, of the plurality of synchronization signal groups is less than or equal to a fourth threshold.

Specifically, to indicate the terminal to select a plurality of target synchronization signals to perform a random access process, the network-side device may send the second indication information to the terminal. The second indication information is used to indicate the terminal to perform random access that is based on a plurality of synchronization signals. Optionally, the network-side device may further indicate the terminal to perform a specific type of random access based on a plurality of synchronization signals. For example, the network-side device indicates the terminal to perform Contention Based Random Access (CBRA) or

Contention Free Random Access (CFRA) based on a plurality of synchronization signals. Then, after receiving the second indication information sent by the network-side device, the terminal may perform random access that is based on a plurality of synchronization signals. Further, optionally, the second indication information indicates the plurality of target synchronization signals used for random access that is based on the plurality of synchronization signals.

Optionally, the terminal may alternatively determine, based on a measured downlink path loss, whether to perform random access based on the plurality of synchronization signals. Optionally, when a downlink path loss reference is lower than a threshold configured by the system, it indicates that quality of a radio environment is poor, and the terminal may choose to perform random access based on a plurality of synchronization signals to improve a success rate of random access.

Optionally, after failures of random access performed by the terminal based on a single synchronization signal are greater than or equal to a preset third threshold, it indicates that a success rate of random access performed by the terminal based on the single synchronization signal is low or the terminal cannot successfully access the network side based on the single synchronization signal. In this case, the terminal may choose to perform random access based on a plurality of synchronization signals, so as to improve the access success rate and shorten the access delay.

Optionally, the network-side device may alternatively send the third indication information to the terminal. The third indication information is used to indicate that an area in which the terminal is located is a cell free area, and/or indicate that the terminal is served jointly by TRPs of a transmission reception point TRP cooperative cluster. In this case, after receiving the third indication information, the terminal may choose to perform random access based on a plurality of synchronization signals.

Optionally, if a difference of the signal quality, obtained by the terminal through measurement, of the plurality of synchronization signal groups is less than or equal to a fourth threshold, it indicates that quality of a radio environment in an area in which the terminal is located is poor or overlapping coverage exists. In this case, the terminal may choose to perform random access based on a plurality of synchronization signals to improve a success rate of random access. For example, when channel quality of the N synchronization signal groups measured by the terminal is similar, that is, when a difference between channel quality of an optimal synchronization signal group and channel quality of a suboptimal/another synchronization signal group is less than a predefined threshold, the terminal may select a plurality of synchronization signal groups to perform a random access procedure, so as to improve a success rate of random access.

In an embodiment, the first information further includes fourth indication information, where the fourth indication information is used to indicate that synchronization signal grouping is supported, and/or indicate that the network-side device supports the terminal in performing random access by using a plurality of synchronization signals.

Specifically, the first information further includes fourth indication information, where the fourth indication information is used to indicate that synchronization signal grouping is supported, and/or indicate that the network-side device supports the terminal in performing random access by using a plurality of synchronization signals. After receiving the fourth indication information sent by the network-side device, the terminal may further determine the group information of the synchronization signal based on the first indication information in the first information, and perform random access based on the plurality of synchronization signals.

In an embodiment, the performing, by the terminal, random access by using the plurality of target synchronization signals includes:
sending, by the terminal, an MSG1 corresponding to each of the target synchronization signals to the network-side device based on an RO associated with each of the target synchronization signals;
monitoring, by the terminal based on a quasi-co-location parameter of each of the target synchronization signals, an MSG2 sent by the network-side device; and
sending, by the terminal, an MSG3 to the network-side device based on a transmit spatial parameter of a target synchronization signal corresponding to the received MSG2.

Specifically, after determining the plurality of target synchronization signals, the terminal may perform random access by using the plurality of target synchronization signals. Optionally, as shown in FIG. 7, the terminal sends, based on an associated RO of each target synchronization signal in one association period, an MSG1 corresponding to each target synchronization signal to the network-side device. Optionally, the base station separately configures a random access RO resource for each SSB group, for example, separately configures different time-frequency resources. As another example, a same time-frequency resource is configured, and different preamble sets are configured. Optionally, the terminal respectively sends N synchronization signals on RO resources of different times by using N different antenna modules.

Optionally, after receiving the plurality of MSG1 sent by the terminal, the network-side device sends corresponding MSG2 to the terminal by using a synchronization signal as a quasi-co-location parameter. Optionally, the N TRPs respectively use N SSB quasi-co-location parameters.

Optionally, the terminal may monitor, based on a quasi-co-location parameter of each target synchronization signal, the MSG2 sent by the network-side device. Optionally, the terminal monitors the MSG2 based on the N SSB quasi-co-location parameters. If the terminal successfully receives, by using the quasi-co-location parameter corresponding to the synchronization signal, the MSG2 sent by the network-side device, the terminal sends an MSG3 to the network-side device based on a transmit spatial parameter of a target synchronization signal corresponding to the received MSG2, so as to implement random access based on a plurality of synchronization signals.

For example, after the terminal sends an MSG1 corresponding to SSB#i (one of the N SSBs), the terminal enables a RAR monitoring window, and performs MSG2/RAR monitoring by using SSB#i as a quasi-co-location reference. If the terminal successfully receives the MSG2 by using the SSB#i quasi-co-location reference, and verification of a Random Access Preamble Identifier (RAPID) succeeds, the terminal sends the MSG3 based on a transmit spatial parameter corresponding to a receive spatial parameter of SSB#i.

In an embodiment, in a case that the terminal receives a plurality of MSG2 sent by the network-side device, the determining, by the terminal, a transmit spatial parameter of an MSG3 based on a target synchronization signal corresponding to the received MSG2, and sending the MSG3 to the network-side device includes:
selecting, by the terminal, a transmit spatial parameter of a target synchronization signal corresponding to any one of the plurality of MSG2, and sending the MSG3 to the network-side device; or
selecting, by the terminal, transmit spatial parameters of target synchronization signals corresponding to all of the plurality of MSG2, and sending the MSG3 to the network-side device.

Specifically, in a process in which the terminal performs random access based on a plurality of synchronization signals, in a case that the terminal receives a plurality of MSG2 sent by the network side, the terminal may select a transmit spatial parameter of a target synchronization signal corresponding to any one of the plurality of MSG2, and send the MSG3 to the network-side device, and no longer respond to the received remaining MSG2. Alternatively, the terminal selects transmit spatial parameters of target synchronization signals corresponding to all of the plurality of MSG2, and sends the MSG3 to the network-side device.

For example, the terminal determines ROs corresponding to the N synchronization signals based on the system message configuration, and sends the MSG1. Optionally, the N synchronization signals are respectively sent by using N different antenna modules. After receiving the MSG1 by using a TRP#j module corresponding to a synchronization signal#i (one of the N synchronization signals), the base station uses the TRP#j module to send the MSG2/RAR by using the synchronization signal #i as a quasi-co-location reference. Optionally, for a terminal with a plurality of antenna modules, the terminal receives the synchronization signal #i by using the antenna module #k, and receives, by using the antenna module #k, an MSG2/RAR that is quasi-co-located with the synchronization signal #i. If the terminal successfully receives the MSG2 by using the quasi-co-location reference of the synchronization signal #i, and if the terminal successfully receives the MSG2 by using quasi-co-location references of a plurality of synchronization signals, and a verification succeeds, the terminal sends the MSG3 by selecting a transmit spatial parameter corresponding to a receive spatial parameter of a synchronization signal corresponding to any MSG2 (for example, the RAR that is successfully received at the earliest or latest time, or the RAR with best signal quality, or the RAR for which the MSG3 is scheduled at the earliest or latest time, or the RAR that is independently selected by the terminal), and no longer responds to the remaining MSG2. Alternatively, the terminal sends the MSG3 by selecting transmit spatial parameters corresponding to receive spatial parameters of all synchronization signals that are successfully received and pass a verification.

In an embodiment, the sending, by the terminal, an MSG1 corresponding to each of the target synchronization signals to the network-side device based on an RO of each of the target synchronization signals includes:
sending, by the terminal, the MSG1 corresponding to each of the target synchronization signals to the network-side device by using at least one beam based on the RO of each of the target synchronization signals, where the beam is used to determine a transmission reception point TRP cooperative cluster serving the terminal, the transmission reception point TRP cooperative cluster includes a plurality of target TRPs, and the target TRPs are TRPs receiving a same beam.

Specifically, the terminal sends the MSG1 corresponding to each of the target synchronization signals to the network-side device by using at least one beam based on the RO of each of the target synchronization signals. Optionally, for target synchronization signals with the same RO, the terminal sends the MSG1 to the network-side device by using the same beam. Then, TRPs receiving the same beam may be used as a target cluster in cooperative clusters of the terminal for jointly serving the terminal.

In an embodiment, an MSG2 sent by each of the target TRPs included in the TRP cooperative cluster includes a uniform temporary cell radio network temporary identifier TC-RNTI and information about an uplink resource used to send the MSG3, where the information about the uplink resource includes a transmit spatial parameter.

Specifically, the TRP cooperative cluster includes a plurality of target TRPs, and the MSG2 sent by the plurality of target TRPs in the cooperative cluster to the terminal includes a uniform temporary cell radio network temporary identifier TC-RNTI and a same uplink resource used to send the MSG3. In other words, the TC-RNTIs and spatial parameters in the MSG2 sent by the TRPs in the same TRP cooperative cluster are the same. Further, when the terminal sends the MSG3 to the network-side device, the MSG3 also carries a set formed by the TC-RNTI in the MSG2 received by the terminal, so that the network-side device can use TRPs corresponding to the same TC-RNTI in the received MSG3 as the TRP cooperative cluster serving the terminal, to jointly serve the terminal, thereby quickly constructing a TRP cooperative cluster.

For example, the terminal determines ROs corresponding to the N synchronization signals based on the system message configuration, and sends the MSG1 by using the same beam. It may be understood that the N synchronization signals are respectively sent by N different TRP modules. The beam may be independently selected by the terminal or specified by the network. TRPs receiving the same beam serve the same terminal in a form of a cooperative cluster, scramble PDCCH information by using an RA-RNTI, and send an MSG2 to the terminal. The TRPs in the cooperative cluster allocate, in the MSG2, a uniform TC-RNTI and a same MSG3 uplink resource to the terminal, that is, configure a same transmit spatial parameter.

In an embodiment, a quantity of the plurality of target synchronization signals is N, N is an integer greater than 1, and the determining, by the terminal, a plurality of target synchronization signals based on the information about the synchronization signal groups includes:
determining, by the terminal, a first target synchronization signal based on location information of the RAR window; and
determining, by the terminal, N-1 target synchronization signals based on the first target synchronization signal and the location information of the RAR window, where a time domain resource occupied by a synchronization signal group in which the N-1 target synchronization signals are located does not overlap a time domain resource occupied by the RAR window.

Specifically, when determining the plurality of target synchronization signals, the terminal may determine the first target synchronization signal based on location information of the RAR window. Optionally, a start time of the RAR window is a start time of a timeslot in which a first reference channel is located after the MSG1 is sent. Optionally, the reference channel may be a Physical Downlink Control Channel (PDCCH) type Type1, a Control Resource Set (CORESET) #0, or another downlink channel.

For example, the start time of the RAR window is a start boundary of a timeslot in which the first control resource set is located after the MSG1 is sent, and RAR windows of SSBs and ROs have the same length. As shown in FIG. 6, an uplink timeslot is temporarily used as an RO resource. A plurality of ROs are configured in the uplink timeslot, and the RO is associated with a plurality of SSBs. After receiving an SSB and obtaining a cell synchronization message and a system message, the terminal determines a quantity of SSBs in the cell and an RO resource configuration, and then the terminal may classify ROs having the same start time of the RAR window into one group, and further determine, based on an association relationship between an RO and an SSB, an associated SSB group and a target synchronization signal in the RO group.

After the terminal determines the first target synchronization signal and the location information of the RAR window, the terminal may determine N subsequent SSBs based on the first selected SSB and the RAR window. Optionally, if an uplink timeslot exists and an RO resource exists within a time during which the RAR window is enabled, the SSB group corresponding to the RO resource cannot send the PRACH. The terminal may select a plurality of ROs within one SSB to RO association period or association pattern period, so as to ensure that RAR windows corresponding to the ROs do not overlap each other. Optionally, the determined quantity of target synchronization signals is not greater than the association period divided by a length of the RAR window, or is not greater than the association pattern period divided by a length of the RAR window.

In an embodiment, if the terminal does not receive, within a preset time range, an MSG2 sent by the network-side device, the terminal performs at least one of the following operations:
redetermining a target synchronization signal group and/or a plurality of target synchronization signals, and performing random access; and
increasing power of the plurality of target synchronization signals, and performing random access.

Specifically, in a process in which the terminal selects a plurality of target synchronization signals to perform random access, if the terminal does not receive, within a preset time range, an MSG2 sent by the network-side device after the terminal sends a plurality of MSG1 to the network-side device, it indicates that the current random access process performed by the terminal fails. In this case, the terminal may redetermine the target synchronization signal group and/or determine a target synchronization signal in each target synchronization signal group in a case that the target synchronization signal group varies, and perform random access, or increase power of a plurality of target synchronization signals, so as to improve a success rate of random access.

For example, if monitoring windows of the terminal for N MSG1 all time out, it is considered that MSG1 transmission fails. In this case, the terminal performs MSG1 transmission again by selecting N′ SSBs, where N′ may not be equal to N. Optionally, the terminal may alternatively re-select N′ SSB groups, and select one SSB from the N′ SSB groups to perform a next random access attempt. Alternatively, the terminal re-selects an SSB from the N selected SSB groups to perform a next random access attempt. When the next random access attempt is performed, if the selected SSB is unchanged, transmit power of the corresponding MSG1 is increased, or if the selected SSB group is unchanged, transmit power of the corresponding MSG1 in the SSB group is increased.

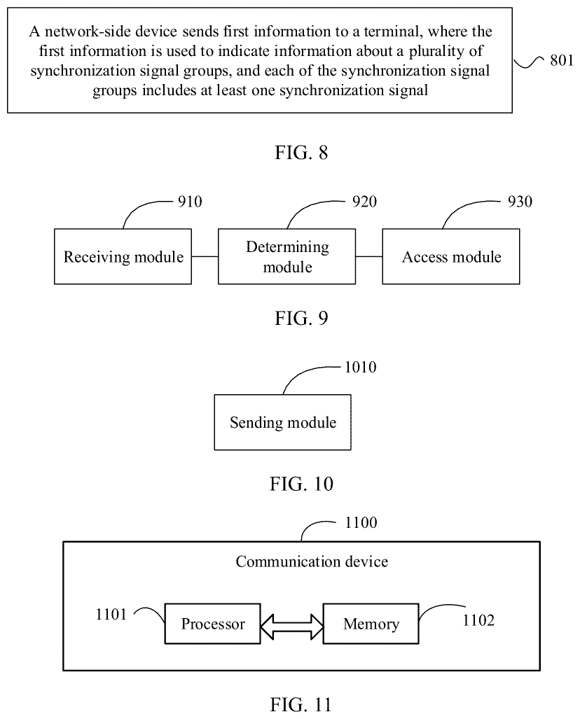

FIG. 8 is a second schematic flowchart of a random access method according to an embodiment of this application. As shown in FIG. 8, the method provided in this embodiment includes the following steps.

Step 801: A network-side device sends first information to a terminal, where the first information is used to indicate information about a plurality of synchronization signal groups, and each of the synchronization signal groups includes at least one synchronization signal.

Optionally, the first information includes at least one of the following:
first indication information, where the first indication information is used to indicate the information about the plurality of synchronization signal groups;
a quantity threshold of the synchronization signal groups to which the plurality of target synchronization signals belong;
an association relationship between a synchronization signal and an access occasion RO; and
a configuration parameter of an RO resource.

Optionally, the information about the plurality of synchronization signal groups includes at least one of the following:
information about a synchronization signal included in each of the synchronization signal groups;
information about a synchronization signal group to which each synchronization signal in a synchronization signal set belongs;
a quantity of synchronization signals in each of the synchronization signal groups;
a quantity of synchronization signal groups;
identifiers of the plurality of synchronization signals;
a first synchronization signal set, where the first synchronization signal set includes a synchronization signal identifier corresponding to a first synchronization signal in each synchronization signal group;
a second synchronization signal set, where the second synchronization signal set includes a synchronization signal identifier corresponding to a last synchronization signal in each synchronization signal group;
a synchronization signal bitmap, where target separation information in the synchronization signal bitmap is used to classify a plurality of synchronization signals into a plurality of synchronization signal groups;
an optional maximum quantity of target synchronization signal groups; and
location information of a random access response RAR window corresponding to each RO.

Optionally, the quantity of a plurality of target synchronization signals is less than or equal to the quantity of antenna modules supported by the terminal, or the quantity of simultaneously received signal streams.

Optionally, the random access method further includes at least one of the following:
sending, by the network-side device, second indication information to the terminal, where the second indication information is used to indicate the terminal to perform random access that is based on a plurality of synchronization signals; and
sending, by the network-side device, third indication information to the terminal, where the third indication information is used to indicate that an area in which the terminal is located is a cell free area, and/or indicate that the terminal is served jointly by TRPs of a transmission reception point TRP cooperative cluster.

Optionally, the first information further includes fourth indication information, where the fourth indication information is used to indicate that synchronization signal grouping is supported, and/or indicate that the network-side device supports the terminal in performing random access by using a plurality of synchronization signals.

Optionally, the random access method further includes at least one of the following:
receiving, by the network-side device, an MSG1 corresponding to each of the target synchronization signals sent by the terminal, where the MSG1 is sent by the terminal based on an RO associated with each of the target synchronization signals;
sending, by the network-side device, a message MSG2 to the terminal based on a quasi-co-location parameter of each of the target synchronization signals; and
receiving, by the network-side device, an MSG3 sent by the terminal, where the MSG3 is sent by the terminal based on a transmit spatial parameter of a target synchronization signal corresponding to the received MSG2.

Optionally, the receiving, by the network-side device, an MSG1 corresponding to each of the target synchronization signals sent by the terminal includes:
receiving, by the network-side device, the MSG1 corresponding to each of the target synchronization signals sent by the terminal, where the MSG1 is sent by the terminal by using at least one beam based on the RO of each of the target synchronization signals; and
determining, by the network-side device based on the at least one beam, a transmission reception point TRP cooperative cluster serving the terminal, where the TRP cooperative cluster includes a plurality of target TRPs, and the target TRPs are TRPs receiving a same beam.

Optionally, an MSG2 sent by each of the target TRPs included in the TRP cooperative cluster includes a uniform temporary cell radio network temporary identifier TC-RNTI and information about an uplink resource used to send the MSG3, where the information about the uplink resource includes a transmit spatial parameter.

Optionally, the network-side device constructs, based on a TC-RNTI in the MSG2, a TRP cooperative cluster serving the terminal, where the TRP cooperative cluster includes a plurality of TRPs and the MSG3 includes TC-RNTIs in all received MSG2.

Optionally, a start time of the RAR window is a start time of a timeslot in which a first reference channel is located after the MSG1 is sent.

Optionally, a quantity of the plurality of target synchronization signals is N, N is an integer greater than 1, N is less than or equal to a first value, and the first value is an association period or an association pattern period between a synchronization signal and an RO divided by a length of the RAR window.

The random access method provided in this embodiment of this application may be performed by a virtual apparatus. In an embodiment of this application, a random access apparatus provided in an embodiment of this application is described by using an example in which the virtual apparatus performs the random access method.

FIG. 9 is a first schematic structural diagram of a random access apparatus according to an embodiment of this application. As shown in FIG. 9, the random access apparatus is applied to a terminal and includes:
a receiving module 910, configured to receive first information sent by a network-side device, where the first information is used to indicate information about a plurality of synchronization signal groups, and each of the synchronization signal groups includes at least one synchronization signal;
a determining module 920, configured to determine a plurality of target synchronization signals based on the information about the plurality of synchronization signal groups; and
an access module 930, configured to perform random access by using the plurality of target synchronization signals.

Optionally, the first information includes at least one of the following:
first indication information, where the first indication information is used to indicate the information about the plurality of synchronization signal groups;
a quantity threshold of the synchronization signal groups to which the plurality of target synchronization signals belong;
an association relationship between a synchronization signal and an access occasion RO; and
a configuration parameter of an RO resource.

Optionally, the information about the plurality of synchronization signal groups includes at least one of the following:
information about a synchronization signal included in each of the synchronization signal groups;
information about a synchronization signal group to which each synchronization signal in a synchronization signal set belongs;
a quantity of synchronization signals in each of the synchronization signal groups;
a quantity of synchronization signal groups;
identifiers of the plurality of synchronization signals;
a first synchronization signal set, where the first synchronization signal set includes a synchronization signal identifier corresponding to a first synchronization signal in each synchronization signal group;
a second synchronization signal set, where the second synchronization signal set includes a synchronization signal identifier corresponding to a last synchronization signal in each synchronization signal group;
a synchronization signal bitmap, where target separation information in the synchronization signal bitmap is used to classify a plurality of synchronization signals into a plurality of synchronization signal groups;
an optional maximum quantity of target synchronization signal groups; and
location information of a random access response RAR window corresponding to each RO.

Optionally, the determining module 920 is specifically configured to determine at least one target synchronization signal group based on signal quality of a synchronization signal in the synchronization signal group; and
determine the plurality of target synchronization signals based on each of the target synchronization signal group.

Optionally, the determining module 920 is specifically configured to determine signal quality of each synchronization signal group based on the signal quality of the synchronization signal in the synchronization signal group; and
select at least one target synchronization signal group based on the signal quality of each synchronization signal group.

Optionally, the determining module 920 is specifically configured to use a synchronization signal with optimal signal quality in each target synchronization signal group as the plurality of target synchronization signals; and/or
use a synchronization signal with signal quality greater than or equal to a first threshold in each target synchronization signal group as the plurality of target synchronization signals.

Optionally, the quantity of a plurality of target synchronization signals is less than or equal to the quantity of antenna modules supported by the terminal, or the quantity of simultaneously received signal streams.

Optionally, the access module 930 is specifically configured to perform random access by using the plurality of target synchronization signals in at least one of the following cases:
second indication information sent by the network-side device is received, where the second indication information is used to indicate the terminal to perform random access that is based on a plurality of synchronization signals;
a downlink path loss is less than or equal to a second threshold;
a quantity of failures of random access that is performed based on a single synchronization signal is greater than or equal to a third threshold;
third indication information sent by the network-side device is received, where the third indication information is used to indicate that an area in which the terminal is located is a cell free area, and/or indicate that the terminal is served jointly by TRPs of a transmission reception point TRP cooperative cluster; and
a signal quality difference, obtained through measurement, of the plurality of synchronization signal groups is less than or equal to a fourth threshold.

Optionally, the first information further includes fourth indication information, where the fourth indication information is used to indicate that synchronization signal grouping is supported, and/or indicate that the network-side device supports the terminal in performing random access by using a plurality of synchronization signals.

Optionally, the access module 930 is specifically configured to send an MSG1 corresponding to each of the target synchronization signals to the network-side device based on an RO associated with each of the target synchronization signals;
monitor, based on a quasi-co-location parameter of each of the target synchronization signals, a message MSG2 sent by the network-side device; and
send an MSG3 to the network-side device based on a transmit spatial parameter of a target synchronization signal corresponding to the received MSG2.

Optionally, the access module 930 is further configured to select a transmit spatial parameter of a target synchronization signal corresponding to any one of the plurality of MSG2, and send the MSG3 to the network-side device; or
select transmit spatial parameters of target synchronization signals corresponding to all of the plurality of MSG2, and send the MSG3 to the network-side device.

Optionally, the access module 930 is specifically configured to send the MSG1 corresponding to each of the target synchronization signals to the network-side device by using at least one beam based on the RO of each of the target synchronization signals, where the beam is used to determine a transmission reception point TRP cooperative cluster serving the terminal, the transmission reception point TRP cooperative cluster includes a plurality of target TRPs, and the target TRPs are TRPs receiving a same beam.

Optionally, an MSG2 sent by each of the target TRPs included in the TRP cooperative cluster includes a uniform temporary cell radio network temporary identifier TC-RNTI and information about an uplink resource used to send the MSG3, where the information about the uplink resource includes a transmit spatial parameter.

Optionally, the MSG3 includes TC-RNTIs in all received MSG2, the TC-RNTI is used to construct a TRP cooperative cluster serving the terminal, and the TRP cooperative cluster includes a plurality of TRPs.

Optionally, a start time of the RAR window is a start time of a timeslot in which a first reference channel is located after the MSG1 is sent.

Optionally, the determining module 920 is specifically configured to determine a first target synchronization signal based on location information of the RAR window; and
determine N-1 target synchronization signals based on the first target synchronization signal and the location information of the RAR window, where a time domain resource occupied by a synchronization signal group in which the N-1 target synchronization signals are located does not overlap a time domain resource occupied by the RAR window.

Optionally, N is less than or equal to a first value, and the first value is an association period or an association pattern period between a synchronization signal and an RO divided by a length of the RAR window.

Optionally, the access module 930 is specifically configured to perform at least one of the following operations if an MSG2 sent by the network-side device is not received within a preset time range:
redetermining a target synchronization signal group and/or a plurality of target synchronization signals, and performing random access; and
increasing power of the plurality of target synchronization signals, and performing random access.

FIG. 10 is a second schematic structural diagram of a random access apparatus according to an embodiment of this application. As shown in FIG. 10, the random access apparatus is applied to a terminal and includes:
a sending module 1010, configured to send first information to a terminal, where the first information is used to indicate information about a plurality of synchronization signal groups, and each of the synchronization signal groups includes at least one synchronization signal.

Optionally, the first information includes at least one of the following:
first indication information, where the first indication information is used to indicate the information about the plurality of synchronization signal groups;
a quantity threshold of the synchronization signal groups to which the plurality of target synchronization signals belong;
an association relationship between a synchronization signal and an access occasion RO; and
a configuration parameter of an RO resource.

Optionally, the information about the plurality of synchronization signal groups includes at least one of the following:
information about a synchronization signal included in each of the synchronization signal groups;
information about a synchronization signal group to which each synchronization signal in a synchronization signal set belongs;
a quantity of synchronization signals in each of the synchronization signal groups;
a quantity of synchronization signal groups;
identifiers of the plurality of synchronization signals;
a first synchronization signal set, where the first synchronization signal set includes a synchronization signal identifier corresponding to a first synchronization signal in each synchronization signal group;
a second synchronization signal set, where the second synchronization signal set includes a synchronization signal identifier corresponding to a last synchronization signal in each synchronization signal group;
a synchronization signal bitmap, where target separation information in the synchronization signal bitmap is used to classify a plurality of synchronization signals into a plurality of synchronization signal groups;
an optional maximum quantity of target synchronization signal groups; and
location information of a random access response RAR window corresponding to each RO.

Optionally, the quantity of a plurality of target synchronization signals is less than or equal to the quantity of antenna modules supported by the terminal, or the quantity of simultaneously received signal streams.

Optionally, the sending module 1010 is specifically configured to send second indication information to the terminal, where the second indication information is used to indicate the terminal to perform random access that is based on a plurality of synchronization signals; and
send third indication information to the terminal, where the third indication information is used to indicate that an area in which the terminal is located is a cell free area, and/or indicate that the terminal is served jointly by TRPs of a transmission reception point TRP cooperative cluster.

Optionally, the first information further includes fourth indication information, where the fourth indication information is used to indicate that synchronization signal grouping is supported, and/or indicate that the network-side device supports the terminal in performing random access by using a plurality of synchronization signals.

Optionally, the sending module 1010 is specifically configured to receive an MSG1 corresponding to each of the target synchronization signals sent by the terminal, where the MSG1 is sent by the terminal based on an RO associated with each of the target synchronization signals;
send a message MSG2 to the terminal based on a quasi-co-location parameter of each of the target synchronization signals; and
receive an MSG3 sent by the terminal, where the MSG3 is sent by the terminal based on a transmit spatial parameter of a target synchronization signal corresponding to the received MSG2.

Optionally, the sending module 1010 is specifically configured to receive the MSG1 corresponding to each of the target synchronization signals sent by the terminal, where the MSG1 is sent by the terminal by using at least one beam based on the RO of each of the target synchronization signals; and
determine, based on the at least one beam, a transmission reception point TRP cooperative cluster serving the terminal, where the TRP cooperative cluster includes a plurality of target TRPs, and the target TRPs are TRPs receiving a same beam.

Optionally, an MSG2 sent by each of the target TRPs included in the TRP cooperative cluster includes a uniform temporary cell radio network temporary identifier TC-RNTI and information about an uplink resource used to send the MSG3, where the information about the uplink resource includes a transmit spatial parameter.

Optionally, the sending module 1010 is specifically configured to construct, based on a TC-RNTI in the MSG2, a TRP cooperative cluster serving the terminal, where the TRP cooperative cluster includes a plurality of TRPs and the MSG3 includes TC-RNTIs in all received MSG2.

Optionally, a start time of the RAR window is a start time of a timeslot in which a first reference channel is located after the MSG1 is sent.

Optionally, a quantity of the plurality of target synchronization signals is N, N is an integer greater than 1, N is less than or equal to a first value, and the first value is an association period or an association pattern period between a synchronization signal and an RO divided by a length of the RAR window.

The virtual apparatus in this embodiment of this application may be an electronic device, for example, an electronic device with an operating system, or may be a component such as an integrated circuit or a chip in the electronic device. The electronic device may be a terminal, or may be another device different from a terminal. For example, the terminal may include but is not limited to the foregoing listed types of the terminal 11. The another device may be a server, a Network Attached Storage (NAS), or the like. This is not specifically limited in this embodiment of this application.

The virtual apparatus provided in this embodiment of this application can implement various processes implemented in the method embodiments of FIG. 2 to FIG. 7, and achieve a same technical effect. To avoid repetition, details are not described herein again.

FIG. 11 is a schematic structural diagram of a communication device according to an embodiment of this application. As shown in FIG. 11, the communication device 1100 includes a processor 1101 and a memory 1102. The memory 1102 stores a program or instructions capable of running on the processor 1101. For example, when the communication device 1100 is a terminal, the program or the instructions are executed by the processor 1101 to implement the steps in the foregoing embodiments of the random access method, and same technical effects can be achieved. When the communication device 1100 is a network-side device, the program or the instructions are executed by the processor 1101 to implement the steps in the foregoing embodiments of the random access method, and same technical effects can be achieved. To avoid repetition, details are not described herein again.

An embodiment of this application further provides a terminal, including a processor and a communication interface, where the communication interface is configured to receive first information sent by a network-side device, where the first information is used to indicate information about a plurality of synchronization signal groups, and each of the synchronization signal groups includes at least one synchronization signal; and the processor is configured to determine a plurality of target synchronization signals based on the information about the plurality of synchronization signal groups; and perform random access by using the plurality of target synchronization signals. The terminal embodiment corresponds to the foregoing method embodiment on the terminal side. Each implementation process and implementation of the foregoing method embodiment may be applied to the terminal embodiment, and same technical effects can be achieved.

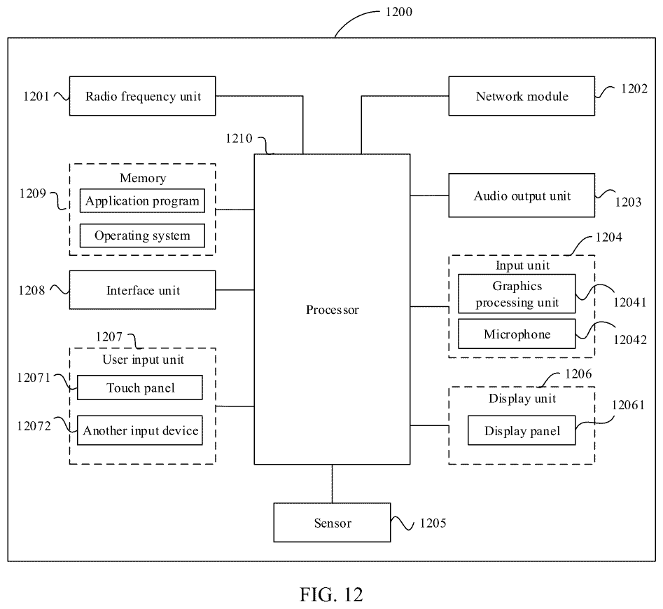

FIG. 12 is a schematic structural diagram of a terminal according to an embodiment of this application. As shown in FIG. 12, the terminal 1200 includes but is not limited to at least some of components such as a radio frequency unit 1201, a network module 1202, an audio output unit 1203, an input unit 1204, a sensor 1205, a display unit 1206, a user input unit 1207, an interface unit 1208, a memory 1209, and a processor 1210.

A person skilled in the art may understand that the terminal 1200 may further include a power supply (for example, a battery) that supplies power to each component. The power supply may be logically connected to the processor 1210 by using a power management system, to implement functions such as charging management, discharging management, and power consumption management through the power management system. The structure of the terminal shown in FIG. 12 does not constitute a limitation on the terminal. The terminal may include more or fewer components than those shown in the figure, or combine some components, or have different component arrangements. Details are not described herein again.

It should be understood that in this embodiment of this application, the input unit 1204 may include a Graphics Processing Unit (GPU) 12041 and a microphone 12042. The graphics processing unit 12041 processes image data of a still picture or a video obtained by an image capture apparatus (for example, a camera) in a video capture mode or an image capture mode. The display unit 1206 may include a display panel 12061, and the display panel 12061 may be configured in a form of a liquid crystal display, an organic light-emitting diode, or the like. The user input unit 1207 includes at least one of a touch panel 12071 or another input device 12072. The touch panel 12071 is also referred to as a touchscreen. The touch panel 12071 may include two parts: a touch detection apparatus and a touch controller. The another input device 12072 may include but is not limited to a physical keyboard, a function key (such as a volume control key or an on/off key), a trackball, a mouse, and an operating lever. Details are not described herein again.

In this embodiment of this application, after receiving downlink data from a network-side device, the radio frequency unit 1201 may transmit the downlink data to the processor 1210 for processing. In addition, the radio frequency unit 1201 may send uplink data to a network-side device. Generally, the radio frequency unit 1201 includes but is not limited to an antenna, an amplifier, a transceiver, a coupler, a low-noise amplifier, a duplexer, and the like.

The memory 1209 may be configured to store a software program or instructions and various types of data. The memory 1209 may mainly include a first storage area for storing a program or instructions and a second storage area for storing data. The first storage area may store an operating system, an application program or instructions required by at least one function (for example, a sound play function or an image play function), and the like. In addition, the memory 1209 may include a volatile memory or a non-volatile memory, or the memory 1209 may include both a volatile memory and a non-volatile memory. The non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 1209 in this embodiment of this application includes but is not limited to these memories and any other suitable type of memory.

The processor 1210 may include one or more processing units. Optionally, the processor 1210 integrates an application processor and a modem processor. The application processor mainly processes operations related to an operating system, a user interface, an application program, and the like. The modem processor, for example, a baseband processor, mainly processes a wireless communication signal. It may be understood that, the foregoing modem processor may not be integrated into the processor 1210.

The radio frequency unit 1201 is configured to receive first information sent by a network-side device, where the first information is used to indicate information about a plurality of synchronization signal groups, and each of the synchronization signal groups includes at least one synchronization signal; and the processor 1210 is configured to determine a plurality of target synchronization signals based on the information about the plurality of synchronization signal groups; and perform random access by using the plurality of target synchronization signals.

Optionally, the first information includes at least one of the following:
first indication information, where the first indication information is used to indicate the information about the plurality of synchronization signal groups;
a quantity threshold of the synchronization signal groups to which the plurality of target synchronization signals belong;
an association relationship between a synchronization signal and an access occasion RO; and
a configuration parameter of an RO resource.

Optionally, the information about the plurality of synchronization signal groups includes at least one of the following:
information about a synchronization signal included in each of the synchronization signal groups;
information about a synchronization signal group to which each synchronization signal in a synchronization signal set belongs;
a quantity of synchronization signals in each of the synchronization signal groups;
a quantity of synchronization signal groups;
identifiers of the plurality of synchronization signals;
a first synchronization signal set, where the first synchronization signal set includes a synchronization signal identifier corresponding to a first synchronization signal in each synchronization signal group;
a second synchronization signal set, where the second synchronization signal set includes a synchronization signal identifier corresponding to a last synchronization signal in each synchronization signal group;
a synchronization signal bitmap, where target separation information in the synchronization signal bitmap is used to classify a plurality of synchronization signals into a plurality of synchronization signal groups;
an optional maximum quantity of target synchronization signal groups; and
location information of a random access response RAR window corresponding to each RO.

Optionally, the processor 1210 is specifically configured to determine at least one target synchronization signal group based on signal quality of a synchronization signal in the synchronization signal group; and
determine the plurality of target synchronization signals based on each of the target synchronization signal group.

Optionally, the processor 1210 is specifically configured to determine signal quality of each synchronization signal group based on the signal quality of the synchronization signal in the synchronization signal group; and
select at least one target synchronization signal group based on the signal quality of each synchronization signal group.

Optionally, the processor 1210 is specifically configured to use a synchronization signal with optimal signal quality in each target synchronization signal group as the plurality of target synchronization signals; and/or
use a synchronization signal with signal quality greater than or equal to a first threshold in each target synchronization signal group as the plurality of target synchronization signals.

Optionally, the quantity of a plurality of target synchronization signals is less than or equal to the quantity of antenna modules supported by the terminal, or the quantity of simultaneously received signal streams.

Optionally, the processor 1210 is specifically configured to perform random access by using the plurality of target synchronization signals in at least one of the following cases:
second indication information sent by the network-side device is received, where the second indication information is used to indicate the terminal to perform random access that is based on a plurality of synchronization signals;
a downlink path loss is less than or equal to a second threshold;
a quantity of failures of random access that is performed based on a single synchronization signal is greater than or equal to a third threshold;
third indication information sent by the network-side device is received, where the third indication information is used to indicate that an area in which the terminal is located is a cell free area, and/or indicate that the terminal is served jointly by TRPs of a transmission reception point TRP cooperative cluster; and
a signal quality difference, obtained through measurement, of the plurality of synchronization signal groups is less than or equal to a fourth threshold.

Optionally, the first information further includes fourth indication information, where the fourth indication information is used to indicate that synchronization signal grouping is supported, and/or indicate that the network-side device supports the terminal in performing random access by using a plurality of synchronization signals.

Optionally, the processor 1210 is specifically configured to send an MSG1 corresponding to each of the target synchronization signals to the network-side device based on an RO associated with each of the target synchronization signals;
monitor, based on a quasi-co-location parameter of each of the target synchronization signals, a message MSG2 sent by the network-side device; and
send an MSG3 to the network-side device based on a transmit spatial parameter of a target synchronization signal corresponding to the received MSG2.

Optionally, the processor 1210 is further configured to select a transmit spatial parameter of a target synchronization signal corresponding to any one of the plurality of MSG2, and send the MSG3 to the network-side device; or
select transmit spatial parameters of target synchronization signals corresponding to all of the plurality of MSG2, and send the MSG3 to the network-side device.

Optionally, the processor 1210 is specifically configured to send the MSG1 corresponding to each of the target synchronization signals to the network-side device by using at least one beam based on the RO of each of the target synchronization signals, where the beam is used to determine a transmission reception point TRP cooperative cluster serving the terminal, the transmission reception point TRP cooperative cluster includes a plurality of target TRPs, and the target TRPs are TRPs receiving a same beam.

Optionally, an MSG2 sent by each of the target TRPs included in the TRP cooperative cluster includes a uniform temporary cell radio network temporary identifier TC-RNTI and information about an uplink resource used to send the MSG3, where the information about the uplink resource includes a transmit spatial parameter.

Optionally, the MSG3 includes TC-RNTIs in all received MSG2, the TC-RNTI is used to construct a TRP cooperative cluster serving the terminal, and the TRP cooperative cluster includes a plurality of TRPs.

Optionally, a start time of the RAR window is a start time of a timeslot in which a first reference channel is located after the MSG1 is sent.

Optionally, the processor 1210 is specifically configured to determine a first target synchronization signal based on location information of the RAR window; and
determine N-1 target synchronization signals based on the first target synchronization signal and the location information of the RAR window, where a time domain resource occupied by a synchronization signal group in which the N-1 target synchronization signals are located does not overlap a time domain resource occupied by the RAR window.

Optionally, N is less than or equal to a first value, and the first value is an association period or an association pattern period between a synchronization signal and an RO divided by a length of the RAR window.

Optionally, the processor 1210 is specifically configured to perform at least one of the following operations if an MSG2 sent by the network-side device is not received within a preset time range:
redetermining a target synchronization signal group and/or a plurality of target synchronization signals, and performing random access; and
increasing power of the plurality of target synchronization signals, and performing random access.

An embodiment of this application further provides a network-side device, including a processor and a communication interface, where the communication interface is configured to send first information to a terminal, where the first information is used to indicate information about a plurality of synchronization signal groups, and each of the synchronization signal groups includes at least one synchronization signal. The network-side device embodiment corresponds to the foregoing method embodiment for the network-side device, and each implementation process and implementation of the foregoing method embodiment can be applied to the network-side device embodiment, and same technical effects can be achieved.

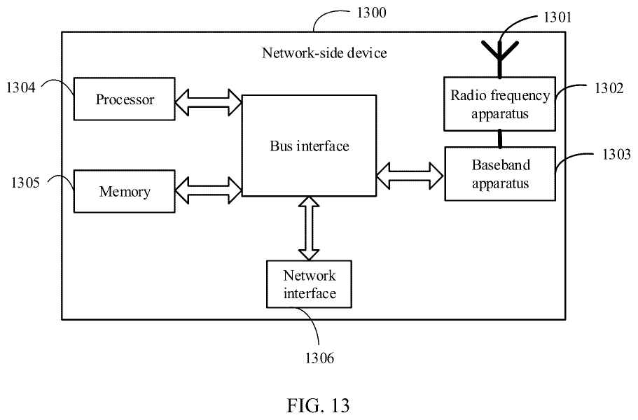

FIG. 13 is a schematic structural diagram of a network-side device according to an embodiment of this application. As shown in FIG. 13, the network-side device 1300 includes an antenna 1301, a radio frequency apparatus 1302, a baseband apparatus 1303, a processor 1304, and a memory 1305. The antenna 1301 is connected to the radio frequency apparatus 1302. In an uplink direction, the radio frequency apparatus 1302 receives information through the antenna 1301, and sends the received information to the baseband apparatus 1303 for processing. In a downlink direction, the baseband apparatus 1303 processes to-be-sent information, and sends processed information to the radio frequency apparatus 1302. After processing the received information, the radio frequency apparatus 1302 sends processed information through the antenna 1301.

The method performed by the network-side device in the foregoing embodiment may be implemented in the baseband apparatus 1303. The baseband apparatus 1303 includes a baseband processor.

For example, the baseband apparatus 1303 may include at least one baseband board. A plurality of chips are disposed on the baseband board. As shown in FIG. 13, one of the chips is, for example, the baseband processor, and is connected to the memory 1305 by using a bus interface, to invoke a program in the memory 1305 to perform an operation of a network device shown in the foregoing method embodiment.

The network-side device may further include a network interface 1306. For example, the interface is a common public radio interface (common public radio interface, CPRI).

Specifically, the network-side device 1300 in this embodiment of this application further includes instructions or a program stored in the memory 1305 and capable of running on the processor 1304. The processor 1304 invokes the instructions or the program in the memory 1305 to perform the random access method described above, and same technical effects are achieved. To avoid repetition, details are not described herein again.

An embodiment of this application further provides a communication system, including a terminal and a network-side device, where the terminal may be configured to perform the steps of the random access method described above, and the network-side device may be configured to perform the steps of the random access method described above.

An embodiment of this application further provides a readable storage medium. The readable storage medium may be volatile or may be non-volatile. The readable storage medium stores a program or instructions, and the program or the instructions are executed by a processor to implement the processes in the foregoing embodiments of the random access method, and same technical effects can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement the processes in the foregoing embodiments of the random access method, and same technical effects can be achieved. To avoid repetition, details are not described herein again.

It should be understood that, the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes in the foregoing embodiments of the random access method, and same technical effects can be achieved. To avoid repetition, details are not described herein again.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element. In addition, it should be noted that, the scope of the method and apparatus in the implementations of this application is not limited to performing functions in a sequence shown or discussed, and may further include performing functions in a basically simultaneous manner or in a reverse order based on the functions involved. For example, the described method may be performed in an order different from the order described, and various steps may be added, omitted, or combined. In addition, features described with reference to some examples may be combined in other examples.

Based on the foregoing descriptions of the implementations, a person skilled in the art may clearly understand that the method in the foregoing embodiments may be implemented by software and a necessary general-purpose hardware platform, or certainly may be implemented by hardware. However, in many cases, the former is a better implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific implementations. The foregoing specific implementations are merely illustrative rather than restrictive. Inspired by this application, a person of ordinary skill in the art may develop many other manners without departing from principles of this application and the protection scope of the claims, and all such manners fall within the protection scope of this application.

1. A random access method, comprising:
receiving, by a terminal, first information sent by a network-side device, wherein the first information is used to indicate information about a plurality of synchronization signal groups, and each of the synchronization signal groups comprises at least one synchronization signal;
determining, by the terminal, a plurality of target synchronization signals based on the information about the plurality of synchronization signal groups; and
performing, by the terminal, random access by using the plurality of target synchronization signals.

2. The random access method according to claim 1, wherein the first information comprises at least one of the following:
first indication information, wherein the first indication information is used to indicate the information about the plurality of synchronization signal groups;
a quantity threshold of the synchronization signal groups to which the plurality of target synchronization signals belong;
an association relationship between a synchronization signal and an Access Occasion (RO); or
a configuration parameter of an RO resource.

3. The random access method according to claim 2, wherein the information about the plurality of synchronization signal groups comprises at least one of the following:
information about a synchronization signal comprised in each of the synchronization signal groups;
information about a synchronization signal group to which each synchronization signal in a synchronization signal set belongs;
a quantity of synchronization signals in each of the synchronization signal groups;
a quantity of synchronization signal groups;
identifiers of a plurality of synchronization signals;
a first synchronization signal set, wherein the first synchronization signal set comprises a synchronization signal identifier corresponding to a first synchronization signal in each synchronization signal group;
a second synchronization signal set, wherein the second synchronization signal set comprises a synchronization signal identifier corresponding to a last synchronization signal in each synchronization signal group;
a synchronization signal bitmap, wherein target separation information in the synchronization signal bitmap is used to classify a plurality of synchronization signals into a plurality of synchronization signal groups; or
location information of a Random Access Response (RAR) window corresponding to each RO.

4. The random access method according to claim 1, wherein the determining, by the terminal, a plurality of target synchronization signals based on the information about the plurality of synchronization signal groups comprises:
determining, by the terminal, at least one target synchronization signal group based on signal quality of a synchronization signal in the synchronization signal group; and
determining, by the terminal, the plurality of target synchronization signals based on each of the target synchronization signal group.

5. The random access method according to claim 4, wherein the determining, by the terminal, at least one target synchronization signal group based on signal quality of a synchronization signal in the synchronization signal group comprises:
determining, by the terminal, signal quality of each synchronization signal group based on the signal quality of the synchronization signal in the synchronization signal group; and
selecting, by the terminal, at least one target synchronization signal group based on the signal quality of each synchronization signal group.

6. The random access method according to claim 4, wherein the determining, by the terminal, the plurality of target synchronization signals based on each of the target synchronization signal group comprises at least one of:
using, by the terminal, a synchronization signal with optimal signal quality in each target synchronization signal group as the plurality of target synchronization signals; or
using, by the terminal, a synchronization signal with signal quality greater than or equal to a first threshold in each target synchronization signal group as the plurality of target synchronization signals.

7. The random access method according to claim 1, wherein a quantity of the plurality of target synchronization signals is less than or equal to a quantity of antenna modules supported by the terminal, or a quantity of simultaneously received signal streams.

8. The random access method according to claim 1, wherein the performing, by the terminal, random access by using the plurality of target synchronization signals comprises:
performing, by the terminal, random access by using the plurality of target synchronization signals in at least one of the following cases:
the terminal receives second indication information sent by the network-side device, wherein the second indication information is used to indicate the terminal to perform random access that is based on a plurality of synchronization signals;
a downlink path loss is less than or equal to a second threshold;
a quantity of failures of random access that is performed by the terminal based on a single synchronization signal is greater than or equal to a third threshold;
the terminal receives third indication information sent by the network-side device, wherein the third indication information is used to indicate that an area in which the terminal is located is a cell free area, and/or indicate that the terminal is served jointly by Transmission Reception Points (TRPs) of a TRP cooperative cluster; or
a signal quality difference, obtained by the terminal through measurement, of the plurality of synchronization signal groups is less than or equal to a fourth threshold.

9. The random access method according to claim 1, wherein the first information further comprises fourth indication information, and the fourth indication information is used to indicate that synchronization signal grouping is supported, and/or indicate that the network-side device supports the terminal in performing random access by using a plurality of synchronization signals.

10. The random access method according to claim 1, wherein the performing, by the terminal, random access by using the plurality of target synchronization signals comprises:
sending, by the terminal, an MSG1 corresponding to each of the target synchronization signals to the network-side device based on an RO associated with each of the target synchronization signals;
monitoring, by the terminal based on a quasi-co-location parameter of each of the target synchronization signals, an MSG2 sent by the network-side device; and
sending, by the terminal, an MSG3 to the network-side device based on a transmit spatial parameter of a target synchronization signal corresponding to the received MSG2.

11. The random access method according to claim 10, wherein in a case that the terminal receives a plurality of MSG2 sent by the network-side device, the determining, by the terminal, a transmit spatial parameter of an MSG3 based on a target synchronization signal corresponding to the received MSG2, and sending the MSG3 to the network-side device comprises:
selecting, by the terminal, a transmit spatial parameter of a target synchronization signal corresponding to any one of the plurality of MSG2, and sending the MSG3 to the network-side device; or
selecting, by the terminal, transmit spatial parameters of target synchronization signals corresponding to all of the plurality of MSG2, and sending the MSG3 to the network-side device.

12. The random access method according to claim 10, wherein the sending, by the terminal, an MSG1 corresponding to each of the target synchronization signals to the network-side device based on an RO of each of the target synchronization signals comprises:
sending, by the terminal, the MSG1 corresponding to each of the target synchronization signals to the network-side device by using at least one beam based on the RO of each of the target synchronization signals, wherein the beam is used to determine a transmission reception point TRP cooperative cluster serving the terminal, the transmission reception point TRP cooperative cluster comprises a plurality of target TRPs, and the target TRPs are TRPs receiving a same beam.

13. The random access method according to claim 12, wherein an MSG2 sent by each of the target TRPs comprised in the TRP cooperative cluster comprises a uniform Temporary Cell Radio Network Temporary Identifier (TC-RNTI) and information about an uplink resource used to send the MSG3, wherein the information about the uplink resource comprises a transmit spatial parameter.

14. The random access method according to claim 10, wherein the MSG3 comprises TC-RNTIs in all received MSG2, the TC-RNTI is used to construct a TRP cooperative cluster serving the terminal, and the TRP cooperative cluster comprises a plurality of TRPs.

15. The random access method according to claim 2, wherein a start time of a RAR window is a start time of a timeslot in which a first reference channel is located after the MSG1 is sent.

16. The random access method according to claim 2, wherein a quantity of the plurality of target synchronization signals is N, N is an integer greater than 1, and the determining, by the terminal, a plurality of target synchronization signals based on the information about the synchronization signal groups comprises:
determining, by the terminal, a first target synchronization signal based on location information of the RAR window; and
determining, by the terminal, N-1 target synchronization signals based on the first target synchronization signal and the location information of the RAR window, wherein a time domain resource occupied by a synchronization signal group in which the N-1 target synchronization signals are located does not overlap a time domain resource occupied by the RAR window.

17. The random access method according to claim 16, wherein N is less than or equal to a first value, and the first value is an association period or an association pattern period between a synchronization signal and an RO divided by a length of the RAR window.

18. The random access method according to claim 1, wherein the method further comprises:
in response to the terminal not receiving, within a preset time range, an MSG2 sent by the network-side device, performing by the terminal, at least one of the following operations:
redetermining a target synchronization signal group and/or a plurality of target synchronization signals, and performing random access; or
increasing power of the plurality of target synchronization signals, and performing random access.

19. A random access method, comprising:
sending, by a network-side device comprising at least one hardware processor, first information to a terminal, wherein the first information is used to indicate information about a plurality of synchronization signal groups, and each of the synchronization signal groups comprises at least one synchronization signal.

20. A terminal, comprising:
at least one hardware processor and a memory, wherein the memory stores a program or instructions capable of executing on the at least one hardware processor, and the program or the instructions, when executed by the at least one hardware processor, cause the terminal to:
receive first information sent by a network-side device, wherein the first information is used to indicate information about a plurality of synchronization signal groups, and each of the synchronization signal groups comprises at least one synchronization signal;
determine a plurality of target synchronization signals based on the information about the plurality of synchronization signal groups; and
perform random access by using the plurality of target synchronization signals.
